(19) United States
(12) Patent Application Publication
(10) Pub. No.: US 2012/0008964 A1
(43) Pub. Date: Jan. 12, 2012

(54) Printable Media Sensing Device, System and Method

(75) Inventors: James Costello, Singapore (SG); Rani Saravanan, Singapore (SG); Wee Sin Tan, Singapore (SG)

(73) Assignee: Avago Technologies ECBU (Singapore) Pte. Ltd., Fort Collins, CO (US)

(21) Appl. No.: 12/834,084

(22) Filed: Jul. 12, 2010

(51) Int. Cl. G03G 15/00

(52) U.S. Cl. 399/17

(57) ABSTRACT

Printable media sensing devices, systems and methods are disclosed herein. An array of light emitters projects light through a printable media sheet for detection by a corresponding array of light sensors. A processor is operably connected to the array of light emitters and light sensors, and is configured to activate the light emitters, and receive output signals from the light sensors, and permit the accurate detection and determination of the locations of top of form (TOF) and bottom of form (BOF) for a given printable media sheet, as well as multiple widths corresponding to such sheet. According to some embodiments, the locations of labels on a sheet may also be detected with heightened accuracy, as may regions having no labels disposed thereover.

### FIELD OF THE INVENTION

Various embodiments of the inventions described herein relate to the field of components, devices, systems and methods for printed media sensing and printing.

### BACKGROUND

Having a printer feed, register and print accurately upon a printable media sheet comprising one or more labels disposed above an underlying backing layer can present certain difficulties, especially if the printable media sheet comprises multiple labels, sections of varying width, or portions having offset top edges. Accurately detecting and determining the locations of multiple side edge locations, multiple top edge, locations, multiple labels, and multiple no media or no label locations presents formidable technical challenges. What is needed is a sensing device and corresponding method capable of overcoming these challenges in a cost-effective manner.

### SUMMARY

In some embodiments, there is provided a printable media sensing device comprising a printed media path having a printed media substrate, the printed media substrate being configured to accept thereon and have fed therealong substantially parallel to an axis of transport a printable media sheet comprising one or more labels disposed above an underlying backing layer, the printable media sheet comprising at least a first top edge, and at least first and second side edges defining a first width of the sheet, an array of light emitters configured to project light beams therefrom towards a first side of the printable media sheet, an array of light sensors configured to receive and sense at least portions of the projected light beams transmitted through the printable media sheet to a second side thereof, the second side opposing the first side, the light sensors generating output signals representative of differences in optical transmissivity detected by the respective light sensors corresponding thereto, and a processor configured to control and drive the array of light emitters, and further configured to receive output signals from the array of light sensors and, on the basis of the received output signals, to determine at least one of the width of the sheet and a first location corresponding to the first top edge.

In other embodiments there is provided a method of printing on a printable media, sheet with a printable media sensing device, the sheet comprising one or more labels disposed above an underlying backing layer, at least a first top edge, and at least first and second side edges defining a first width, the printable media sensing device comprising a printed media substrate configured to accept thereon and have fed therealong substantially parallel to an axis of transport the printable media sheet, an array of light emitters configured to project light beams therefrom towards a first side of the printable media sheet, an array of light sensors configured to receive and sense at least portions of the projected light beams transmitted through the printable media sheet to a second side thereof, the second side opposing the first side, the light sensor generating output signals representative of differences in optical transmissivity detected by the respective light sensors corresponding thereto, a processor configured to control and drive the array of light emitters, and further configured to receive output signals from the array of light sensors and, on the basis of the received output signals, to determine at least one of the width of the sheet and a first location corresponding to the first top edge, the method comprising determining at least one of the width of the sheet and the first location. The method may further comprise sending data to a host processor concerning the width of the sheet and the first location.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will, become apparent from the following specification, drawings and claims in which:

FIG. 1 shows a printable media sensing device 10 according to one embodiment;

FIG. 2 shows a portion of device 10 of FIG. 1 with one LED activated;

FIG. 3 shows a portion of device 10 of FIG. 1 with three LEDs activated;

FIG. 4 shows a cross-sectional view of a portion of device 10 of FIG. 1;

FIG. 5 shows one embodiment of an LED driving and control circuit;

FIG. 6 shows one embodiment of a light sensor circuit;

FIG. 7 shows a portion of device 10 of FIG. 1, with corresponding pairs of LEDs and light sensors, identified by oval circles with dashed lines;

FIG. 8 shows another embodiment of device 10 with a stepped printable media sheet disposed therein;

FIG. 9 shows a printable, media sheet subjected to testing in device 10,

FIG. 10 shows a printable media sheet with different regions;

FIG. 11 shows a block diagram of device 10 and its incorporation into a larger printer system, and

FIG. 12 shows a method according to one embodiment of operating device 10.

The drawings are not necessarily to scale. Like numbers refer to like parts or steps throughout the drawings, unless otherwise noted.

### DETAILED DESCRIPTIONS OF SOME EMBODIMENTS

Disclosed and described herein are various embodiments of a printed media sensing device, system and method which employ an array of light emitters in conjunction with an array of light sensors to detect, variations in the amount of light transmitted through various layers in a printable media sheet (e.g., index marks, backing, and labels). These variations arise from different locations or portions, of the sheet having different light transmittance characteristics, which are associated with the differing number and type of layers present in the sheet at such different locations or portions. Light is transmitted through one side of the sheet as the sheet is fed beneath or over the array of light emitters, and the light transmitted to the opposite side of the sheet is detected by the array of light sensors.

The sensed light signals are employed to determine one or more of:
(1) the width or widths of the printable media sheet;
(2) the locations of one or more top and/or bottom edges of the printable media sheet; and/or
(3) the locations of one or more labels disposed on a backing of a printable media sheet.

The various embodiments of printable media sensing devices, systems and methods disclosed herein work on a through-beam principle, and allow increased flexibility in customer application design, as well as other advantages discussed below. Detecting the width of a printable media sheet can permit, automatic media selection through the use of appropriate controlling software, which eliminates the need for a user to select the media width, and also avoid incorrect media selection. Detecting Top Of Form (TOF) or Bottom of Form (BOF) of a printable media sheet, where TOF for BOF may be the top leading or bottom trailing edge of a printable media sheet or the leading or trailing edge of a label disposed on backing of the printable media sheet permits appropriate controlling software to ensure that printing, upon the printable media sheet begins at the correct location on sheet and does not run over the trailing, inside or outside edges of the printable media sheet.

According to some embodiments, the positions of different portions of a printable media sheet may be detected with great accuracy, and hence enable correspondingly accurate printing on desired portions of the printable media sheet, such as on labels disposed thereon. Some embodiments can be configured to permit labels to be differentiated from the backing of the printable media sheet, with or without the use of an index mark (such as a black ink mark printed on the underside, of the backing paper, as employed by some printable media sheet manufacturers, e.g., BROTHER™). Some embodiments are configured to detect printable media sheet TOF locations, widths and/or label locations without the need to employ printable media sheets haying no registration or index marks, thereby eliminating the costs associated with providing printable media sheets having such marks, simplifying manufacturing processes for printable media sheets having labels disposed thereon, and increasing the versatility of ink jet, laser and other types of printers which incorporate the devices, systems and methods described and disclosed herein.

Note that printable media sheets are not limited to sheets having adhesive labels and an underlying backing, but include paper, cardboard, film, construction paper, or any other medium capable of being formed into a sheet and fed into the devices, systems and printers disclosed herein.

Note further that the printable media sensing devices, systems and methods disclosed herein typically provide input signals to a larger printing system having a host processor or microcontroller, or directly to a computer (such as a personal computer) for further processing and decision making.

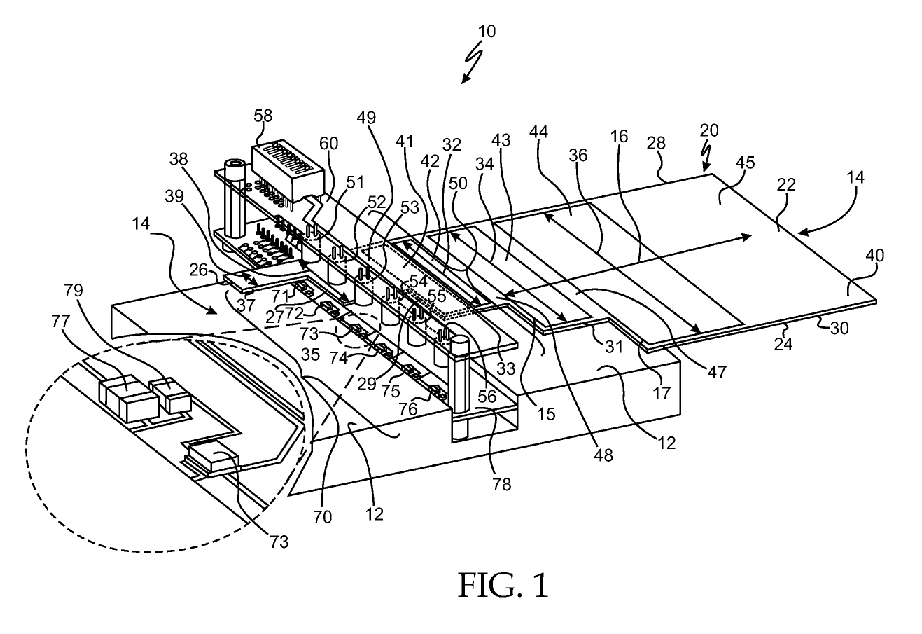

Referring now to FIG. 1, there is shown a printable media sensing device 10. Printed media path 14 comprises printed media substrate 12, which is configured to accept thereon and have fed therealong substantially parallel to axis of transport 16 a printable media sheet 20 along paper or sheet path 14. Sheet 20 comprises one or more labels 41, 42, 43 and 44, which are disposed above an underlying backing layer 40. As shown in FIG. 1, printable media sheet 22 comprises first top edge 26, second top edge 27, third top edge 29, fourth top edge 15 and fifth top edge 17. In the example illustrated in FIG. 1, top edges 26, 27, 29, 15 and 17 are staggered across the width of sheet 22, and the outer edges thereof correspond to varying sheet-widths 32, 34, 36, and 38. First and second side edges 28 and 30 define width 36, while first side edge 28 and second side edge 31 define width 34, first side edge 28 and third side edge 33 define, width 32, first side edge 28 and fourth side edge 35 define width 38, and first side edge 28 and fifth side edge 37 define width 39.

Continuing to refer to FIG. 1, light emitters 51, 52, 53, 54, 55 and 56 form an array of light sources or light emitters 50 mounted on printed circuit board 60, which are configured to project corresponding light beams 61, 62, 63, 64, 65 and 66 therefrom towards first side 22 of printable media sheet 20. An array 70 of light sensors 71, 72, 73, 74 75 and 76 mounted on printed circuit board 78 is configured to receive and sense at least portions of projected light beams 61, 62, 63, 64, 65 and 66 transmitted through printable media sheet 20 to a second side 24 thereof, the second side opposing the first side. Light sensors 71, 72, 73, 74 75 and 76 are configured to generate output-signals representative of differences in optical transmissivity detected by the respective light sensors corresponding thereto.

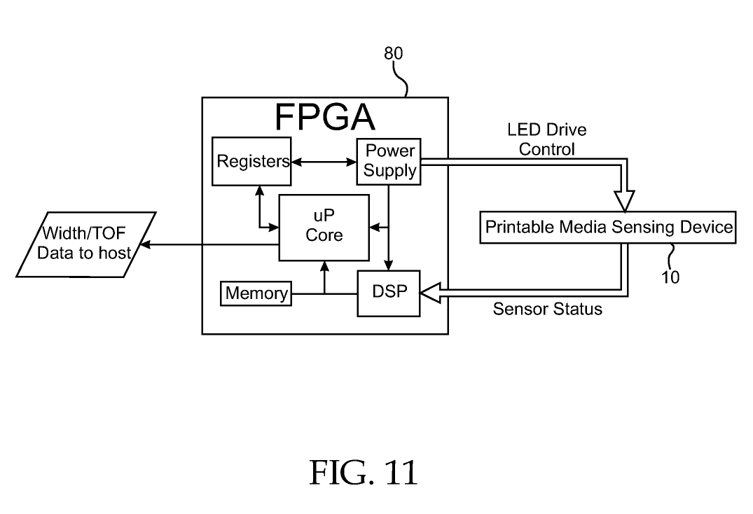

A processor (not shown in FIG. 1; see processor 80 in FIG. 11) is configured, to control and drive array 50 of light emitters 51, 52, 53, 54, 55 and 56, and is further configured to receive output signals from array 70 of light sensors 71, 72, 73, 74, 75 and 76 and, on the basis of the received output signals, to determine at least one of widths 32, 34, 36; 38 and 39 of sheet 20, and/or to detect at least one first location corresponding to one or more of fop edges top edges 26, 27, 29, 15 and 17 (“top-of-form” or TOF; or top edge of the sheet), and/or to detect the locations of labels 41, 42, 43 and 44 disposed atop, backing 40 of sheet 20.

Note that sheet 20 in FIG. 1 contains second locations 45 (or “no media” locations), where no labels are disposed over underlying backing 40. Moreover, gaps 47 between labels are also no media, locations. Accordingly, processor 80 of FIG. 11 may further configured to determine, on the basis of the received output signals, such second no media locations, which correspond to one or more portions of sheet 20 where as described above and as shown in the Figures no labels are disposed over backing 40.

As illustrated in the embodiments of FIGS. 1, 2, 3, 5, 7 and 8, array of light emitters 50 comprises a first number of light emitters (six), and array of light sensors 70 comprises a second number, of light sensors (also six), where the first number equals the second number. Those skilled in the art will understand that any suitable number of light emitters and light sensors may be employed according to the particular design at hand. For example, the first and second numbers may range between about 4 light emitters or sensors, and about 10 light emitters, or sensors. The first and second numbers may also not be equal. While the embodiment of printed media sensing device 10 shown in FIGS. 1, 2, 3, 5, 7 and 8 employs six LEDs or light sources to form array 50 and six light sensors to form array 70, and thereby permits the locations of labels and no media areas on printable media sheets of up to 100 mm in width to be detected accurately therein, device 10 can be scaled up or down for greater or lesser printable media sheet widths 36 depending on the maximum width that is required for the particular application at hand. Note further that the “up” and “down” positions of light emitter array 50 and light sensor array 70 may be reversed, as may the “up” and “down” orientations of sheet 20 with respect to substrate 12 and arrays 50 and 70.

Referring now to FIGS. 1, 2 and 3, light emitters 51, 52, 53, 54, 55 and 56 are independently addressable so each light emitter can be activated and then sensed or measured as needed. This allows sensor array 70 and processor 80 to determine the width(s) and other properties of printable media sheet 20 discussed above in accordance with the light signals received by each of light sensors or detectors 71, 72, 73, 74, 75 and 76.

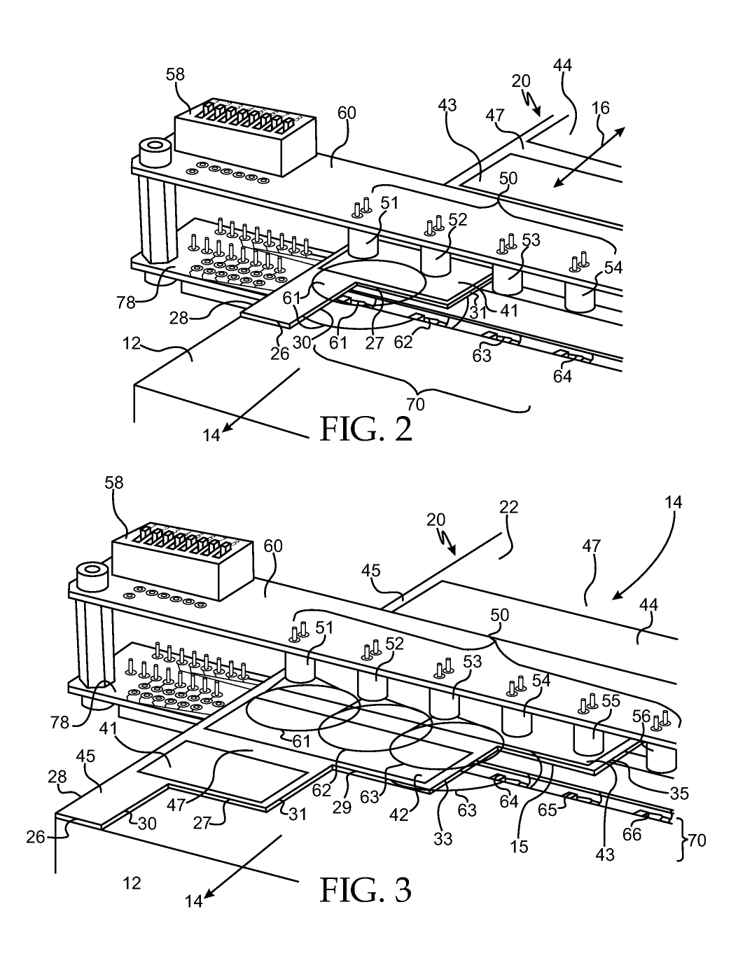

As shown in FIG. 2, a portion of sheet 20 having narrow width 38 is disposed between light emitter array 50 and light sensor array 70, and only light emitter 51 is activated to produced projected beam 61. The output signal provided by light sensor 71 is essentially zero, while light sensor 72 detects approximately 25% of a full-scale signal.

As shown in FIG. 3, where sheet 20 has been advanced along sheet or paper path 14, and where three light emitters 51, 52 and 53 are activated, light sensors 71 and 72 provide essentially zero output while light sensor 73 yields a 25% of full-scale output signal.

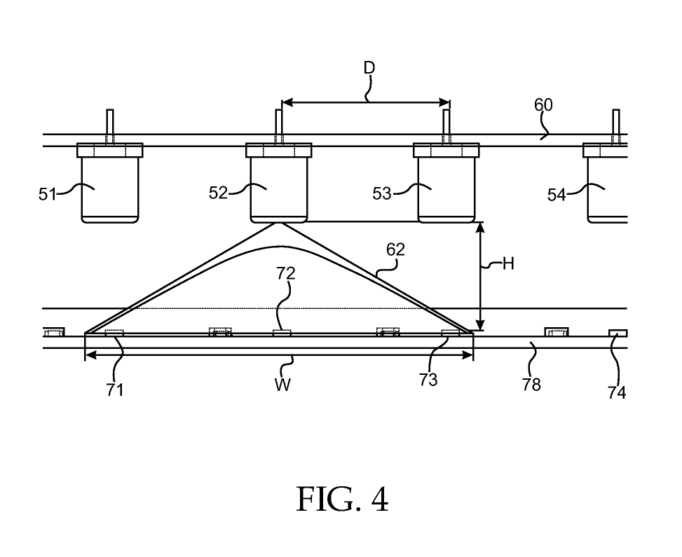

FIG. 4 shows a side view of a portion of light emitter array 50 (light emitters 51, 52, 53 and 54) and light sensor array 70 (light sensors 71, 72, 73 and 74), where it will be seen that projected light beam 62 is emitted by light emitter 52. The width of beam 62 is “W,” the height of beam 62 is “H,” and the spacing between light emitters and light sensors is “D.” In FIG. 4, a full-scale signal is generated by light sensor 72, while light sensors 71 and 73, being situated further form the central axis of projected beam 62 than light sensor 72, register 25% of a full-scale signal. Thus, in the embodiment illustrated in FIGS. 1 through 4, the light emitted by a single LED can be detected by up to three different adjoining APDS-9005 light sensors. The positioning of the LEDs and APDS-9005 light sensors is determined-during design by the beam angle of the LEDs. The LEDs of light sensor array 50 of provide a Lambertian output of 60 degrees, which has been found provide a good balance between optimum coverage with the fewest number of light emitters and sensors.

In the embodiments illustrated in FIGS. 1, 2, 3 and 4, the maximum width of printable media sheet 20 is about 100 mm, the horizontal spacing D between adjoining light emitters and light sensors is about 7 mm (but may range between about 8 mm and about 10 mm), and the vertical, spacing H between light emitter array 50 and light sensor array 70 is about 6 mm, but may range between about 5 mm and about 7 mm. The foregoing dimensions are merely illustrative, and can change depending upon the particular application at hand.

In one embodiment, the individual light sources or emitters of array 50 are AVAGO TECHNOLOGIES™ HLMP-FW67 LEDs, and the individual light sensors of array 70 are AVAGO TECHNOLOGIES™ APDS-9005 light detectors. These products are described in greater detail in the following Data Sheets: (1) Data Sheet for HLMP-CWxx Precision Optical Performance White LED Lamps, AV02-0368EN, Apr. 1, 2008, and (2) Data Sheet for APDS-9005, Miniature Surface-Mount Ambient Light Photo Sensor, AV02-0080EN—Jan. 16, 2007, both of which Data Sheets, are thereby, incorporated by reference herein, each in its respective entirety.

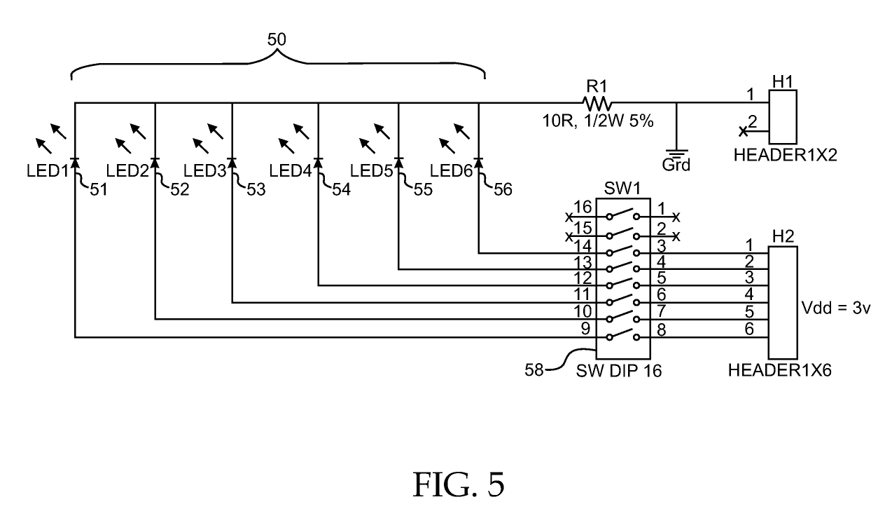

FIG. 5 shows one embodiment of a circuit for light emitter array 50, which is operably connected switches 58, which are configured to open and close under the control of processor 80 of FIG. 11. In the embodiment, circuit for light emitter array 50 shown in FIG. 5, and assuming APDS-9005 light sensors are employed to sense the light generated by the LEDs and circuit of FIG. 5, preferred colors for LEDs 51 through 56 include, but are not limited to, white, yellow and green owing to the fact that APDS-9005 light sensors exhibit the best sensitivities to the wavelengths of light emitted by LEDs of such colors. Other colors and types of LEDs may of course be used, as may other types of light sensors. Moreover, a system designer can enhance printer aesthetics through the use of color LEDs in device 10. LEDs 51 through 55′ may also be covered with tinted or clear acrylic to change printer aesthetics and functionality by, for example, reducing the brightness of or otherwise-filtering light emitted by the light emitters.

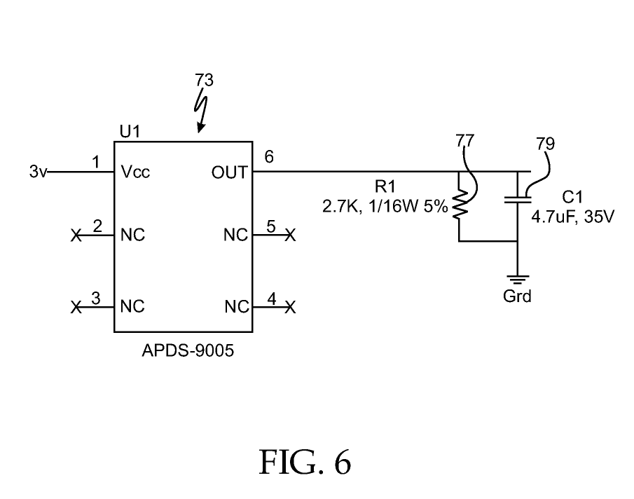

As shown in the embodiment of FIG. 1, resistor 77 and capacitor 79 are included in circuitry associated with light sensor 73; each of light sensors 71, 72, 74, 75 and 76 includes similar, components in their respective sensor circuitry. Light sensors can also be provided which include such circuit components in a single package, as opposed to discrete components disposed on circuit board 78. FIG. 6 shows a circuit with light sensor 73 operably connected to resistor 77 and capacitor 79 to form one embodiment of an individual sensing circuit.

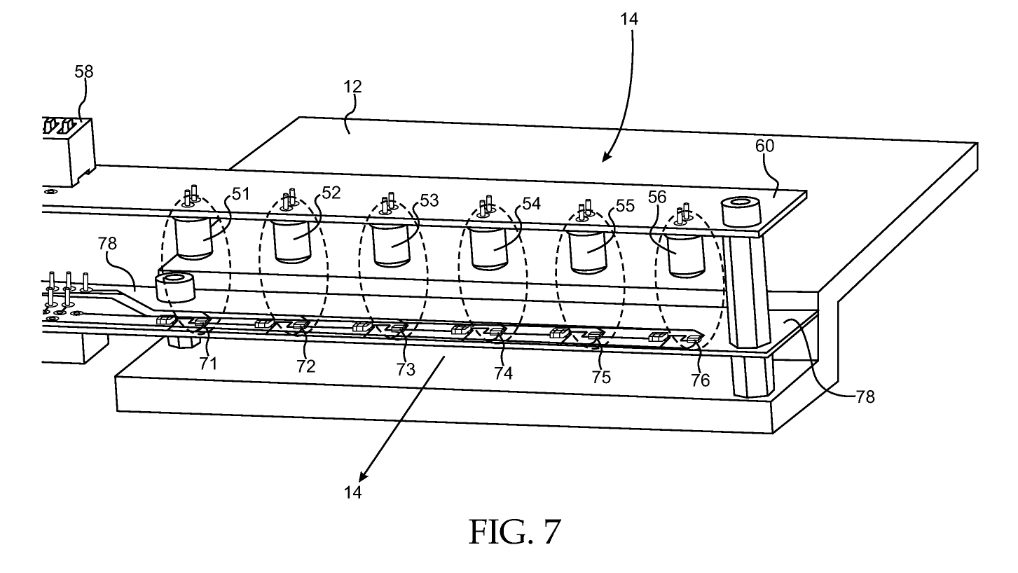

Referring now to FIG. 7, there is shown a top perspective view of one embodiment of a portion of printable media sensing device 10 comprising paper or sheet path 14 with light emitters 51 through 56 and light sensors 71 through 76. As shown, light emitter 51 is aligned vertically directly above light sensor 71, light emitter 52 is aligned vertically directly above light sensor 72, light emitter 53 is aligned vertically directly above light sensor 73, light emitter 54 is aligned vertically directly above light sensor 74, light emitter 55 is aligned vertically directly above light sensor 75, and light emitter 56 is aligned vertically directly above light sensor 76. Thus, each light emitter in light emitter array 50 is associated with a corresponding light sensor in light sensor array 70 disposed and aligned directly therebelow. Other arrangements, configurations and numbers of light emitters and sensors may also be employed, as those skilled in the art will understand.

Table 1 below shows individual LED light activation, test results obtained using printable media-sensing device 10 of FIG. 1; but with no sheet of printable media 20 disposed therein. Table 1 shows the responses generated in light sensors 71, 72, 73, 74, 75 and 76 (light sensors 9005-1, 9005-2, 9005-3, 9005-4, 9005-5 and 9005-6, respectively, in Table 1 below), when each of LEDs 51, 52, 53, 54, 55 and 56 (LED1, LED2, LED3, LED4, LED5 and LED6, respectively, in Table 1 below) is activated, one at a time. As will be seen by referring to Table 1, the 9005 light sensor disposed and aligned directly below an activated LED generates a 100% of full-scale output signal, while neighboring 9005 light sensors to either side of the full-scale output signal 9005 light sensor generate 25% of full-scale output signals.

TABLE 1
Output Signals Generated in Light Sensors when
Light Emitters are Activated Individually

| | Sensor Output Voltage | | | | | |
|---|---|---|---|---|---|---|
| LED Select | 9005-1 | 9005-2 | 9005-3 | 9005-4 | 9005-5 | 9005-6 |
| LED1 | 100 | 25 | 0 | 0 | 0 | 0 |
| LED2 | 25 | 100 | 23 | 0 | 0 | 0 |
| LED3 | 0 | 22 | 100 | 22 | 0 | 0 |
| LED4 | 0 | 0 | 26 | 100 | 24 | 0 |
| LED5 | 0 | 0 | 0 | 24 | 100 | 23 |
| LED6 | 0 | 0 | 0 | 0 | 22 | 100 |

Table 2 below shows multiple LED light activation test results obtained using printable media sensing device 10 of FIG. 1, also with no sheet of printable media 20 disposed therein. Table 2 shows the responses generated in light sensors 71, 72, 73, 74, 75 and 76 (light sensors 9005-1, 9005-2, 9005-3, 9005-4, 9005-5 and 9005-6, respectively, in Table 2 below) when pairs of LEDs 51 and 52 (LED1+LED2 in Table 2), and LEDs 53 and 54 (LED3+LED4 in Table 2) are activated. As will be seen by referring to Table 2, the 9005 light sensors disposed and aligned directly below the pairs of activated LEDs generate 100% of full-scale output signals, while neighboring 9005 light sensors to either side of the full-scale output signal 9005 light sensors generate 20% or 24% of full-scale output signals.

TABLE 2
Output Signals Generated in Light Sensors
when Multiple Light Emitters are Activated

| | Sensor Output Voltage | | | | | |
|---|---|---|---|---|---|---|
| LED Select | 9005-1 | 9005-2 | 9005-3 | 9005-4 | 9005-5 | 9005-6 |
| LED1 + LED2 | 100 | 100 | 20 | 0 | 0 | 0 |
| LED3 + LED4 | 0 | 24 | 100 | 100 | 24 | 0 |

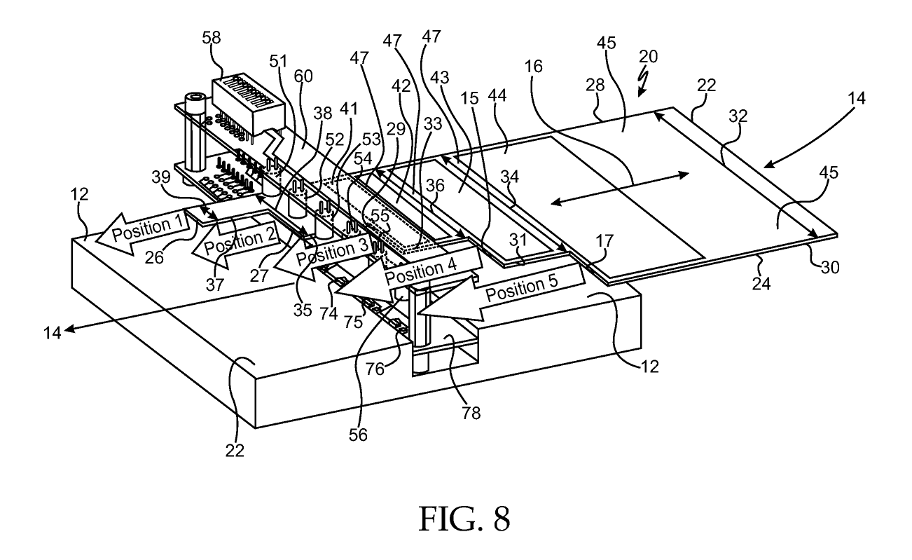

FIG. 8 illustrates printable media sensing device 10 of FIG. 1 with a stepped sheet of printable media 20 disposed therein. Sheet 20 comprises one or more labels 41, 42, 43 and 44, which are disposed above ah underlying backing layer 40. As shown in FIG. 8, printable media sheet 22 comprises first top edge 26, second top edge 27, third top edge 29, fourth top edge 15 and fifth top edge 17. In the example illustrated in FIG. 8, top edges 26, 27, 29, 15 and 17 are staggered across the width of sheet 22, and the outer edges thereof correspond to varying sheet widths 32, 34, 36, and 38. First and second side edges 28 and 30 define width 36, while first side edge 28 and second side edge 31 define width 34, first side edge 28 and third side edge 33 define width 32, first side edge 28 and fourth side edge 35 define width 38, and first side edge 28 and fifth side edge 37 define width 39. Width 39 is 25 mm, while width 36 is 100 mm. Note that maximum width 36 can be increased or decreased by adding or subtracting pairs of light emitters and light sensors.

Table 3 below shows output signal results obtained by sensors 71 (9005-1 in Table 3), 72 (9005-2 in Table 3), 73 (9005-3 in Table 3), 74 (9005-4 in Table 3), 75 (9005-5 in Table 3) and 76 (9005-6 in Table 3) as sheet 20 was moved through device 10 into successive Positions 1, 2, 3, 4 and 5, where all of LEDs 51, 52, 53, 54, 55 and 56 were activated. Successive positioning of sheet 20 in positions 1, 2, 3; 4 and 5 was obtained as follows. Processor 80 provided information regarding the detection of TOF, the edges of sheet 20, and label versus no media portions of sheet 20 was employed to a host processor of a printer, which in turn used such information to control and drive a printer transport mechanism to feed and set positions 1, 2, 3, 4 and 5 of sheet 20. See FIG. 11, where processor 80 is shown. See also U.S. Pat. No. 6,464,417 to Barbera et al, entitled “Method and Apparatus for Print Media Detection,” the entirety of which is hereby incorporated by reference herein, and which discloses printer transport mechanisms and other aspects of a printer that may be adapted in accordance with the teachings disclosed herein.

TABLE 3
Output Signals Generated in Light Sensors with
Sheet 20 in Positions 1 through 5 of FIG. 8

| POSITION | 9005-1 | 9005-2 | 9005-3 | 9005-4 | 9005-5 | 9005-6 |
|---|---|---|---|---|---|---|
| ONE | 23 | 90 | 100 | 100 | 100 | 100 |
| TWO | 23 | 26 | 24 | 100 | 100 | 100 |
| THREE | 23 | 26 | 24 | 23 | 100 | 100 |
| FOUR | 23 | 26 | 24 | 23 | 23 | 100 |
| FIVE | 23 | 26 | 24 | 24 | 24 | 30 |

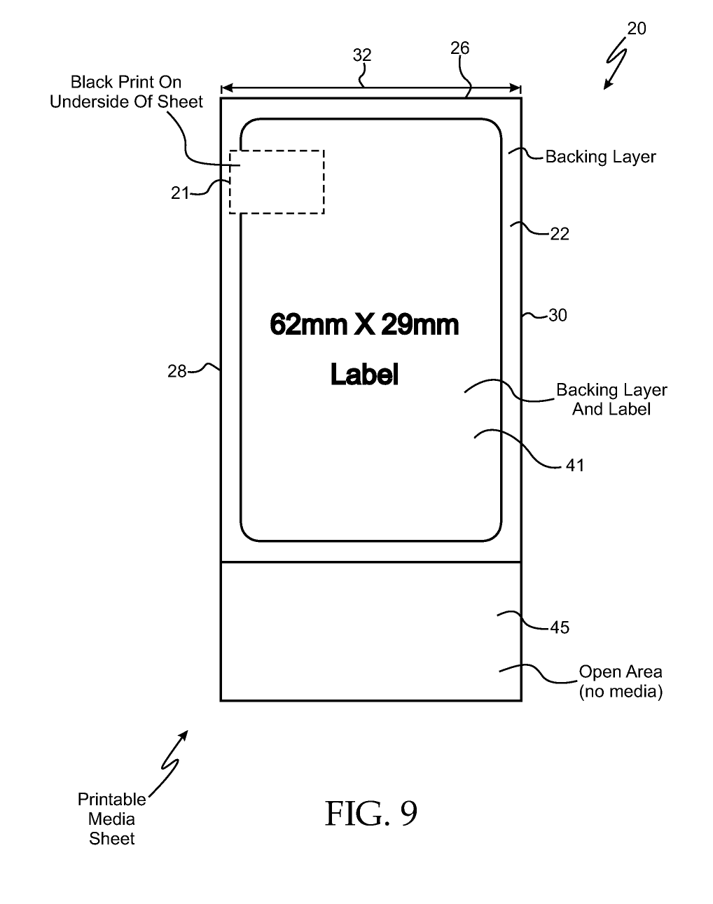

FIG. 9 shows one embodiment of printable media sheet 20 haying label 41 disposed on backing 22, along with an open media area (i.e., no backing and no label). Printable media sheet 20 comprises regions having backing only, an open area with no media or backing disposed therein, a label 41 disposed atop backing layer 22, and an area of black print 21 disposed on the underside of backing 22 (which as; described above is used in some printers to detect label or other locations oh sheet 20, and to register same with respect to a print head of a printer). Test results shown in Table 4 below were obtained by measuring the response of an APDS-9005 light sensor to light shining through no media, backing only, label plus backing, and label plus backing plus black ink. The test results of Table 4 show that device 10 is capable of distinguishing accurately between all the different portions of sheet 20, such as those having backing only, those having backing plus a label, and those having backing plus a label and black ink. The test results of Table 4 also show that device is capable of detecting when no portion of sheet 20 is disposed between light array 50 and light sensor array 70.

TABLE 4
Output Signals Generated in an APDS-9005 Light Sensor
by Various Portions of Sheet 20 of FIG. 9

| | APDS-9005 |
|---|---|
| Media Type | Ouput |
| No Media | 100% |
| Backing Tape ONLY | 45% |
| Label + Backing Tape | 19% |
| Black Ink + Label + Backing Tape | 10% |

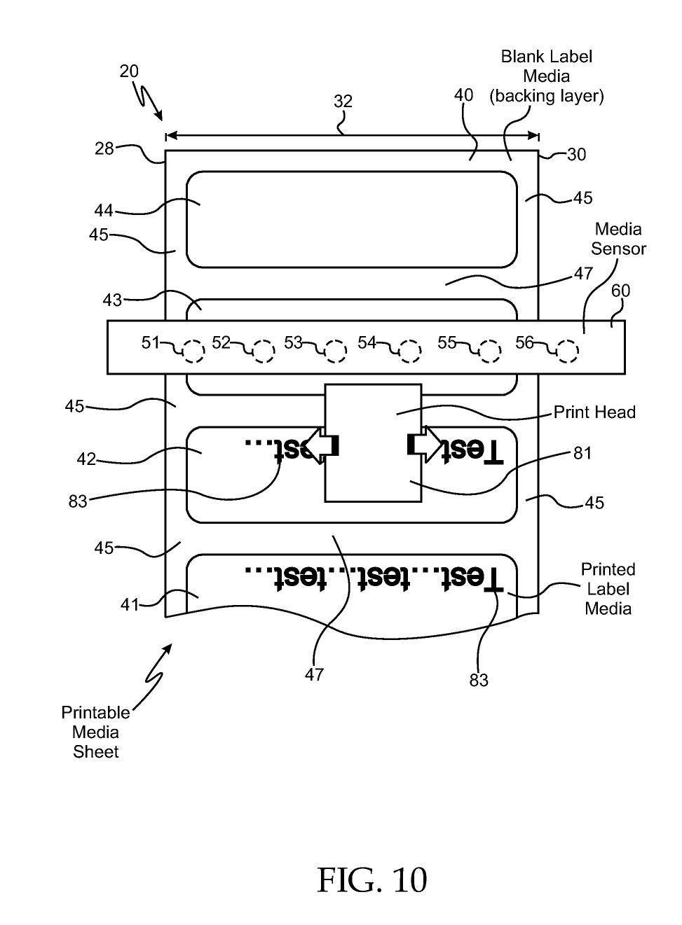

FIG. 10 shows another embodiment of printable sheet media 20 haying different portions corresponding to backing layers only (blank label media); no media areas 45 and 47 (backing only), and labels (41, 42, 43 and 44). As shown, labels 41 and 42 have printing disposed therein through the action of print head 81, which operates under control of a host processor of the printer (see FIG. 11), which receives information front processor 80 (see FIG. 11), which in turn received information from printable media sensing device 10, all of which cooperate with a printer transport mechanism (not shown in the Figures) to print upon the desired portions of sheet 20 with heightened accuracy and registration. In one embodiment, data provided by media sensing device 10 indicate label width, Top of Form (“TOF”) locations, Bottom of Form (“BOF”) locations, and such information is used by the host processor ensure printing occurs only on label media.

FIG. 11 shows a block diagram according to one embodiment, where processor 80 is operably connected to printable media sensing device 10 through an LED drive control circuit (see FIG. 5) and a sensor status line. As shown in FIG. 11, processor 80 is also operably connected to a host processor of a printer, and sends data to and receives data from the host processor. In addition to detecting TOF and edges of sheet 20, and to distinguishing label plus backing regions from backing only or no media regions of sheet 20, processor 80 and the host processor cooperate to effect accurate registration and positioning of sheet 20 with respect to print head 81. Note that while in one embodiment processor 80 is a Field Programmable Gate Array (“FPGA”), processor 80 may be any suitable processing device such as an appropriate controller, computer, CPU, microcontroller, microprocessor, or Application Specific Integrated Circuit (“ASIC”). Continuing to refer to FIG. 11, a Digital Signal Processor (DSP) is operably connected to the array of light sensors and the processor, the DSP being configured to process output signals provided by the array of light sensors and to provide data representative of the processed output signals to the processor.

The printable media devices and systems-disclosed herein may be configured to calibrate or auto-calibrate the light-sensors of light sensor array 70 using appropriate calibration software. Such calibration can be employed to compensate for variations in ambient lighting, the ageing of light emitter and light sensors, and dirt or contamination accumulating in device 10 over time.

Calibration functionality permits the light sensors to work at optimal accuracy at all times. Should there be a problem or failure with any one of the light sensors or light emitters, device 10 would be able to detect such problems or failures during the calibration process, and notify the user of the problem and/or store error codes for later retrieval by a service or maintenance engineer.

According to one embodiment, a system “power-on” initiates self calibration of the light sensors and light emitters. Device 10 cycles through each pair of LEDs and light sensors and measures their received power. The measurement obtained from each light sensor is compared to a reference valve stored in processor 80. Any LED with low power output has its drive current adjusted to maintain a consistent light output, such as can happen when LED power is reduced due to dirt, contamination or age. By way of example, the new post-calibration value for the LED drive is stored in a register of processor 80.

In operation, processor 80 cycles through the LEDs, activating each LED in turn, and measuring, the output of each light sensor. Using these values, the width and TOF of a label can be determined.

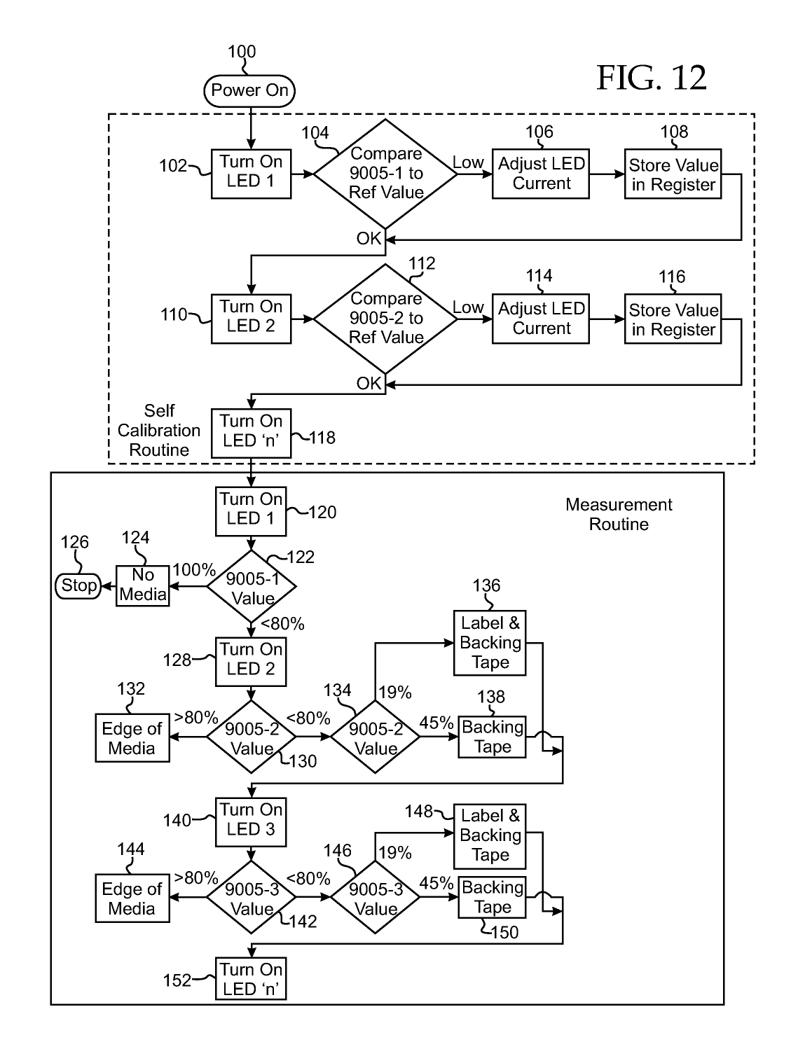

FIG. 12 shows one embodiment of a method of operating device 10 of FIG. 1, where 9005-1 corresponds to light sensor 71, 9005-2 corresponds to light sensor 72, where 9005-3 corresponds to light sensor 73, 9005-4 corresponds to light sensor 74, 9005-5 corresponds to light sensor 75, and 9005-6 corresponds to light sensor 76, LED 1 corresponds to light emitter 51, LED 2 corresponds to light emitter 52, LED 3 corresponds to light emitter 53, LED 3 corresponds to light emitter 53, LED 4 corresponds, to light emitter 54, LED 5 corresponds to light emitter 55, and LED 6 corresponds to light emitter 56. An auto-calibration routine is illustrated in steps 100 through 118, while a measurement routine is illustrated in steps 120 through 152.

Included within the scope of the present invention are methods of making and having made the various components, devices and systems described herein.

Various embodiments of the invention are contemplated in addition to those disclosed hereinabove. The above-described embodiments should be considered as examples of the present invention, rather than as limiting the scope of the invention. In addition to the foregoing embodiments of the invention, review of the detailed description and accompanying drawings will show that there are other embodiments of the invention. Accordingly, many combinations, permutations, variations and modifications of the foregoing embodiments of the invention not set forth explicitly herein will nevertheless fall within the scope of the invention.

We claim:

1. A printable media sensing device, comprising:
a printed media path comprising a printed media substrate, the printed media substrate being configured to accept thereon and have fed therealong substantially parallel to an axis of transport a printable media sheet comprising one or more labels disposed above an underlying backing layer, the printable media sheet comprising at least a first top edge, and at least first and second side edges defining a first width of the sheet;
an array of light emitters configured to project light beams therefrom towards a first side of the printable media sheet;
an array of light sensors configured to receive and sense at least portions of the projected light beams transmitted through the printable media sheet to a second side thereof, the second side opposing the first side, the light sensors being configured to generate output signals representative of differences in optical transmissivity detected by the respective light sensors corresponding thereto, and
a processor configured to control and drive the array of light emitters, and further configured to receive output signals from the array of light sensors and, on the basis of the received output signals, to determine at least one of the width of the sheet and a first location corresponding to the first top edge.

2. The printable media sensing device of claim 1, wherein the array of light emitters comprises a first number of light emitters, and the array of light sensors comprises a second number of light sensors, the first number equalling the second number.

3. The printable media sensing device of claim 1, wherein the processor is further configured to determine, on the basis of the received output signals, a second location corresponding to at least one of a plurality of portions of the sheet not having a label disposed thereover.

4. The printable media sensing device of claim 1, wherein the first top edge corresponds to a top edge of the sheet.

5. The printable media sensing device of claim 1, wherein the processor is configured to sequentially activate each of the light emitters in the array, one at a time, from one side of the array to the other.

6. The printable media sensing device of claim 1, wherein the array of light emitters is arranged at a first angle with respect to the axis of transport.

7. The printable media sensing device of claim 6, wherein the first angle is about 90 degrees.

8. The printable media sensing device of claim 1, wherein the array of light sensors is arranged at a second angle with respect to the axis of transport.

9. The printable media sensing device of claim 8, wherein the second angle is about 90 degrees.

10. The printable media sensing device of claim 1, wherein the array of light emitters comprises between 4 and 10 light emitters.

11. The printable media sensing device of claim 1, wherein each of light emitters is an LED.

12. The printable media sensing device of claim 1, wherein the processor is one of a controller, a micro-controller, a CPU, a microprocessor, an Application Specific Integrated Circuit (ASIC), and a Field Programmable Gate Array (FPGA).

13. The printable media sensing device of claim 1, wherein the first side of the sheet faces upwardly, and the second side of the sheet faces downwardly.

14. The printable media sensing device of claim 1, wherein the first side of the sheet faces downwardly, and the second side of the sheet faces upwardly.

15. The printable media sensing device of claim 1, wherein the processor is configured to determine multiple widths of the sheet.

16. The printable media sensing device of claim 1, wherein the processor is configured to determine multiple top edges of the sheet.

17. The printable media sensing device of claim 1, wherein the array of light emitters is operably connected to a switching device disposed between the array of light emitters and the processor, and the processor is configured to selectably switch on and off selected ones of the light emitters.

18. The printable media sensing device of claim 1, wherein the processor is configured to perform a calibration routine for the device comprising selectively turning selected ones of the light emitters on and off according to a predetermined sequence.

19. The printable media sensing device of claim 18, wherein the processor is configured to perform the calibration routine when the device is initially powered up.

20. The printable media sensing device of claim 18, further comprising a power supply configured to provide current to each of the light emitters under control of the processor.

21. The printable media sensing device of claim 18, wherein the processor is configured to change current drive settings in the power supply for each of the light emitters oh the basis of comparisons between output signals received by the processor during the calibration routine and reference values corresponding to the sensors stored in a memory or register of the processor.

22. The printable media sensing device of claim 18, wherein the current drive settings are adjusted such that each of the light emitters generates substantially the same light output.

23. The printable media sensing device of claim 1, further comprising a Digital Signal Processor (DSP) operably connected to the array of light sensors and the processor, the DSP being configured to process output signals provided by the array of light sensors and to provide data representative of the processed output signals to the processor.

24. The printable media sensing device of claim 3, wherein the device is incorporated into and forms a portion of a printer comprising a host processor, and the processor is operably connected to the host processor and sends data to the host processor concerning the second location corresponding to at least one of the portions not having a label disposed thereover.

25. The printable media sensing device of claim 1, wherein the device is incorporated into and forms a portion of a printer, and the printer comprises a host processor operably connected to the processor.

26. The printable media sensing device of claim 25, wherein the processor sends data to the host processor concerning sheet width or top edge location,

27. The printable media sensing device of claim 25, wherein the printer is one of an ink jet printer and a laser printer.

28. The printable media sensing device of claim 25, wherein the printer adjusts feeding and positioning of the sheet in accordance with data received by the host processor from the processor.

29. A method of printing on a printable media sheet with a printable media sensing device, the sheet comprising one or more labels disposed above an underlying backing layer, at least a first top edge, and at least first and second side edges defining a first width, the printable media sensing device comprising a printed media substrate configured to accept thereon and have fed therealong substantially parallel to an axis of transport the printable media sheet, an array of light emitters configured to project light beams therefrom towards a first side of the printable media sheet, an array of light sensors configured to receive and sense at least portions of the projected light beams transmitted through the printable media sheet to a second side thereof, the second side opposing the first side, the light sensor generating output signals representative of differences in optical transmissivity detected by the respective light sensors corresponding thereto, and a processor configured to control and drive the array of light emitters, and further configured to receive output signals from the array of light sensors and, on the basis of the received output signals, to determine at least one of the width of the sheet and a first location corresponding to the first top edge, the method comprising:
determining at least one of the width of the sheet and the first location

30. The method of claim 29, further comprising sending data to a host processor concerning the width of the sheet and the first location.

31. The method of claim 29, further comprising, on the basis of the received output signals, determining a second location corresponding to at least one of a plurality of portions of the sheet not having a label disposed thereover.

32. The method of claim 31, further comprising sending data to a host processor concerning the second location.

33. The method of claim 29, further comprising sequentially activating the light emitters in the array.

34. The method of claim 29, further comprising selectively turning selected ones of the light emitters on and off according to a predetermined sequence.

35. The method of claim 29, further comprising performing a calibration routine.

36. The method of claim 33, further comprising changing current drive settings for each of the light emitters on the basis of comparisons between output signals generated by the light sensors during the calibration routine and reference values corresponding to the light sensors.

37. The method of claim 36, further comprising adjusting the current drive settings such that each of the light emitters generates substantially the same light output.

38. The method of claim 29, wherein the printable media sensing device is operably connected to a printer having a host processor and the printer adjusts feeding and positioning of the sheet in accordance with data provided to the host processor by the processor.
